(19) United States
(12) Patent Application Publication
(10) Pub. No.: US 2013/0199199 A1
(43) Pub. Date: Aug. 8, 2013

(54) DRIVE FOR A TURBINE AND DRIVE METHOD

(71) Applicant: Horst Jan Moddemann, Bad Honnef (DE)

(72) Inventor: Horst Jan Moddemann, Bad Honnef (DE)

(73) Assignee: AIR-LING GmbH

(21) Appl. No.: 13/518,439

(22) PCT Filed: Jun. 9, 2010
(86) PCT No.: PCT/EP10/58050

§ 371 Date: Jun. 22, 2012

(30) Foreign Application Priority Data
Jun. 10, 2009 (DE) 10 2009 026 881.2

(51) Int. Cl. F02C 7/22

(52) U.S. Cl. CPC F02C 7/22
USPC 60/776; 60/740

(57) ABSTRACT

The invention relates to the drive for a turbine, in particular for an aviation turbine, as well as to a method for operating such a turbine. An aviation turbine is a gas turbine that accelerates an aircraft. The invention further relates to an aircraft having the drive for a turbine. According to the invention, a drive for a turbine is provided with a compressor for compressing air, with a nozzle for injecting a first fuel into the compressed air, and with a combustion chamber for igniting the air-fuel mixture. Furthermore, the drive comprises another nozzle for injecting a second fuel. The nozzle for injecting a first fuel serves for starting the drive or a turbine engine comprising the drive as well as a turbine, which provides mechanical energy by the igniting the air-fuel mixture. Therefore, the first fuel is a conventional fuel, in particular kerosene. It is thus ensured that the engine can be started at any time, because it is, or at least can be, of a conventional design in this regard. The second nozzle serves for injecting a new fuel, which at least at first is a liquid gas. In particular, a mixture of and Bio LNG with a high calorific value, which is drawn from a tank and fed to the combustion chamber in an insulated pressure pipe, is used as the liquid gas.

The invention relates to a drive for a turbine, in particular for an aviation turbine (also referred to as engine), as well as to a method for operating such a turbine. An aviation turbine is a gas turbine that accelerates an aircraft. The invention further relates to an aircraft having the drive for a turbine.

A drive for a turbine comprises means for drawing in air. The drawn-in air is compressed in a compressor of the turbine drive. A fuel is added to the compressed air in a downstream combustion chamber. The mixture of fuel and compressed air is ignited and combusted in the combustion chamber. The combustion causes a temperature increase. The built-up energy is relieved in the subsequent turbine. The turbine converts the thermal energy into mechanical energy, which drives the compressor. The remaining portion of gas energy can also be transformed into mechanical energy through a power turbine, or it is relieved via a nozzle by accelerating the mass of the hot gas, thus generating thrust. The transformed energy is utilized in the manner desired.

Already because of the airspeed, air is compressed prior to entry into a compressor of an aviation engine and thus heated to a stagnation temperature of 120 to 140 degrees Celsius. If the flying speed is very high, for example mach 6, the stagnation temperature can rise to up to over 1000 degrees Celsius.

A modern turbine engine for an aircraft comprises several axial-flow and radial-flow compressors that compress the air to 48 bar and heat it up correspondingly. Then, fuel is injected into the compressed air by means of a special spraying nozzle.

Currently, kerosene is used as a fuel in an aircraft. However, this fuel is limited as regards its quantity. There is therefore a demand for being able to operate an aviation engine with a different fuel.

There is a suggestion in the documents DE 195 24 680 A1 and DE 195 24 681 A1 to alternatively use hydrogen or natural gas as fuel and to transport and store these fuels in a liquid, cooled form. However, these documents only describe how such a liquefied fuel may be stored.

From document EP 0 779 469 A1 it is known to first evaporate liquid gas, such as LNG, and to then feed the gas to a consumer in order thus to drive a vehicle. For example, Documents EP 1 112 461 B1 and DE 100 33 736 A1 disclose driving a gas turbine with natural gas. Document US2006213488A relates to a combustion engine operated with LNG. LNG is evaporated prior to combustion.

LNG, natural gas cooled to 161 degrees Celsius and liquefied or liquefied methane, is difficult to ignite, basically can only be combusted by means of technical atomization by special spraying and mixing nozzles, and therefore is a fuel which can be stored very securely. Methane gas (bio methane) is a relatively quickly renewable raw material and is therefore available also for the long term, in contrast to oil and natural gas.

LNG is considered flame-resistant and basically can be inflamed only in a mechanically atomized form. Atomized LNG has an ignition point of 650 degrees Celsius, which is considerably higher than the ignition point of diesel fuel (250 degrees Celsius) or gasoline (235 degrees Celsius).

For example, in order to modify a diesel engine so that it can be operated with LNG, the injection nozzle must therefore be modified. Moreover, such an engine first has to be started with diesel fuel in order to bring the engine up to operating temperature. A sufficiently high temperature for operating a conventional diesel engine with LNG is not provided until the operating temperature has been reached.

Compared with a diesel engine, further-reaching requirements must be taken into consideration in an aviation engine. For safety reasons, an aviation engine must be capable of being restarted at any operative altitude. However, ambient conditions change very much as the (flight) altitude changes. For example, temperature on the ground may be 40 degrees Celsius, whereas the outside temperature at a customary flight altitude may be −60 degrees Celsius. The air density also changes considerably.

It is the object of the invention to be able to operate a turbine with liquefied gas, in particular with a mixture with a particularly high methane content of LNG and/or liquefied bio-methane (bio-LNG).

In order to achieve the object, a drive for a turbine has the features of claim 1. Advantageous embodiments become apparent from the dependent claims. A method for operating the turbine engine comprises the features of the independent claim.

In order to achieve the object, a drive for a turbine is provided with a compressor for compressing air, with a nozzle for injecting a first fuel into the compressed air, and with a combustion chamber for igniting the air-fuel mixture. Furthermore, the drive comprises another nozzle for injecting a second fuel.

The nozzle for injecting a first fuel serves for starting the drive or a turbine engine comprising the drive as well as a turbine, which provides mechanical energy by igniting the air-fuel mixture. Therefore, the first fuel is a conventional fuel, in particular kerosene. It is thus ensured that the engine can be started at any time because it is, or at least can be, of a conventional design in this regard. The second nozzle serves for injecting a new fuel, which at least at first is a liquid gas. LNG, which is drawn from a tank and fed to the combustion chamber, is used as the liquid gas.

If the drive has been started with a conventional fuel, such as kerosene, then the liquid gas can then be supplied for further operation instead of the first conventional fuel. In this case, it is also advantageous that the operating temperature of the drive can be reached with the conventional fuel before changing over to the second fuel. If the second fuel has a higher ignition temperature compared to the conventional fuel, ignition as a rule does not cause any problems at least if the drive has already reached its operating temperature at the time of the changeover.

Moreover, the object of the invention is achieved by a turbine drive comprising a compressor for compressing air, a nozzle for injecting a fuel into the compressed air, and a combustion chamber for igniting the air-fuel mixture, which comprises a heat exchanger for heating the fuel prior to injecting the fuel into the compressed air. If a liquefied gas, in particular liquefied methane (CH₄) is used as fuel, then this fuel is heated and in particular evaporated by the heat exchanger before the fuel arrives in the combustion chamber. This reduces the technical effort that has to be made in order to then be able to ignite the air-fuel mixture.

In one embodiment, the heat exchanger is located in a space or area into which the compressed and thus heated air is fed. The temperature of the heated air may well be 700° C. In this embodiment, the compressed air is cooled off prior to being mixed with the fuel. The temperature of the ignitable air-fuel mixture is thus reduced. In this manner, the turbine inlet temperature can be reduced while maintaining the same combustion temperature difference, which reduces the formation of nitrogen oxides (NOX). Though high combustion temperatures and pressures in modern engines increase their efficiency factor, they also increase NOₓ formation in the atmosphere drastically at the same time. In the form of the trace gas bromonitrate, nitrogen oxide is known as a decomposer of the earth's ozone layer. Therefore, the reduction of the formation of nitrogen oxides is of utmost importance for the entire aviation and the protection of the earth's climate.

In one embodiment, the heat exchanger is adjacent to the combustion chamber so that the fuel is heated by the heat generated in the combustion chamber. This cooling of the combustion chamber ensures in an improved manner that the combustion chamber is not exposed to temperatures that are so high that the combustion chamber is damaged by them.

Preferably, a combustion chamber is configured with double walls and a heat exchanger is disposed between the two walls of the combustion chamber. The heat exchanger can have a total of at least two pipes in which liquid gas, such as LNG, is evaporated, and which feed evaporated LNG on to a nozzle. The pipes can be equipped with controllable flow-through valves in order to be able to control the flow of liquid gas through the pipes. This improves reliability. The feed pipe of feed pipes for the liquid gas to the nozzle can first open into a ring header and routed onwards from the ring header to one or more nozzles.

However, it is not an absolute requirement that liquefied gas is first evaporated. Using piezo nozzles as well as a very high pressure, LNG can be atomized in such a way that LNG can be directly mixed with the compressed air and ignited. This embodiment is advantageous if the technology is supposed to be simple and if heat exchangers and the like are to be dispensed with.

As a rule, it will be necessary also in this case for starting the drive to start the drive in another way first in order to ensure a start at any time. The start therefore preferably takes place using a previously evaporated gas or using a conventional fuel like kerosene. The gas can be drawn from the tank containing the liquefied gas. A vapor atmosphere which can be utilized for the start is always produced in such a tank.

When an overpressure is produced in the tank, the gas atmosphere has to be pumped out. The pumped-out gas may also be used for the operation of a fuel cell with which an associated aircraft is equipped. In one embodiment of the invention, the electric power that the aircraft requires is generated using such a fuel cell, and is stored, if necessary, with a battery. In this way, the generation of electric power can be uncoupled from the operation of the engine and at the same time be used in such a way that an overpressure in an LNG tank is reduced.

A pressure building up in a tank may quickly exceed the maximum admissible pressure. The admissible pressure may be relatively low, for example only two bars, in order to be able to use tanks consisting of Kevlar®. Such Kevlar® tanks consist of hollow fibers, for example, so that a desired flexibility is provided and the desired safety is thus ensured. If an overpressure builds up in such a tank, then this can also be used for generating electric power using external fuel cells when the aircraft is on the ground. For example, the electric power may be fed into the power grid of the airport when an aircraft has landed and if, for whatever reason, it must now be ensured that the contents of the tank are used without having to defuel the aircraft.

While having the same energy content as kerosene, LNG, which predominantly consists of methane, has about 16% to 20% less weight. If an aircraft is fueled and operated with LNG, this results in advantages with regard to weight.

With the same energy content, LNG produces about 30% less CO2 and 80% fewer nitrogen oxides than kerosene. Moreover, no aromatic compounds are produced. LNG therefore exhibits an environmentally friendlier behavior.

An external efficiency of the aircraft that is improved by 25% as compared with an operation with kerosene can be achieved with the invention. External efficiency of the airplane denotes the transport efficiency of an aircraft, or, in other words, fuel consumption per seat mile.

Because of the invention, maintenance costs for the engine can moreover be reduced because the fuel LNG is free from sulfur and burns more cleanly than kerosene. Therefore, the small turbine cooling holes of the turbine blades, in particular, are blocked or made smaller by dirt to a lesser extent in comparison to kerosene combustion, which is capable of reducing maintenance costs considerably. The thermally insulated tanks required for fueling with LNG can be adapted to the existing cargo holds in an aircraft in order to be able to retrofit aircraft with such tanks. The tanks can be permanently installed or replaceably accommodated in the aircraft.

The invention is explained in more detail below with reference to figures.

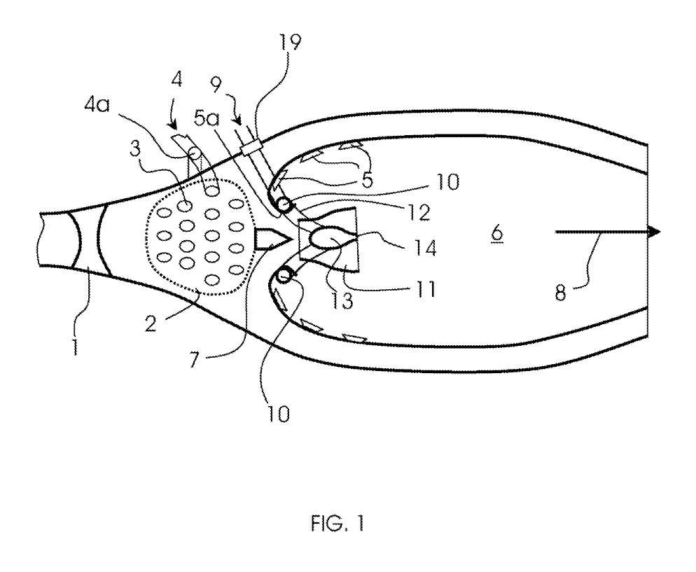

FIG. 1 outlines a section through a portion of an annular combustion chamber or drive for a turbine. The drive comprises a compressor 1 in which drawn-in air is compressed. From the compressor 1, the air, which has been compressed to about 48 bars and heated to about 700° C. arrives in the diffuser area 2, i.e. in an area which expands with regard to its space. In the diffuser area 2 the flow speed of the heated, compressed air slows down. In one embodiment of the invention, a heat exchanger 3 is disposed in this diffuser area 2. The heat exchanger 3 is supplied via a fuel feed annular ring 4a with several inlets 4. LNG is conducted into the heat exchanger 3 through each of those inlets 4 and evaporated, which causes the air present in the diffuser area 2 to cool off. The fuel feeding annular pipe 4a is routed either in the external or internal area of the associated engine in the vicinity of the outer jacket. For reasons related to fluid engineering, the pipe of the heat exchanger 3 has an elliptical cross section in the manner apparent from FIG. 1, so that air is capable of easily flowing through the heat exchanger 3. The long side of the ellipsis thus extenss parallel to the air flow.

The cooled, compressed air is fed into the combustion chamber 6 through wall openings 5 and the ejector 5a along the wall nozzles 7 and 14. Due to the high nozzle fuel speed, the ejector sucks the compressed air into the combustion chamber where the air mixes with the fuel. The LNG evaporated in the heat exchanger 3 arrives at a gas injection nozzle 7 with which gas is injected into the combustion chamber 6. An ignitable fuel-air mixture is thus produced in the combustion chamber, which is relieved via a subsequent turbine, which is not shown, along an arrow 8.

The drive moreover comprises an inlet 9 for kerosene through which kerosene comes into an annular pipe 10. The annular pipe 10 runs around the gas nozzle 7 as a functional component of the combustion chamber ejector. The drive comprises a plurality of such nozzles 7 which, in accordance with the annular shape of the combustion chamber 6, are arranged distributed in an annular fashion. From the annular pipe 10, kerosene is pumped through several lines 12 into the inner space 13 of the mixing nozzle burner 11. The kerosene enters the combustion chamber 6 through the nozzle 14 and is thus atomized. A different ignitable fuel-air mixture is thus produced which ensures that the drive can be started in any situation, i.e. even at great altitudes at very low temperatures of, for example, −50° C.

In the embodiment shown in FIG. 1, LNG is fed into the diffuser chamber at about 200 bars through the heat exchanger into the diffuser chamber. The air pressure in the diffuser chamber is about 48 bars. Evaporated LNG is pressed through the nozzle 7 with a pressure of about 200 bars and thus atomized. Through the ejector and the openings 5 in the wall of the combustion chamber 6, air comes into the combustion space with a pressure of about 48 bars. The nozzle 7 ensures that air exiting through the ejector and from the openings 5 is entrained, so that an optimized mixture of air and fuel is produced in the area of the nozzle. Air is thus optimally swirled around with the fuel.

There is preferably no welded, riveted or screwed connection between the walls of the combustion chamber on the one hand and the mixing nozzle burner 11, the annular pipe 10 for feeding kerosene and the nozzles 14 for kerosene. Instead, there are only clamping connections between the ejector feed sheet and the kerosene-feeding annular pipe 10. In this sense, each mixing nozzle burner 11, via the respective ejector annular pipe 10 is attached, suspended from at least three webs 10a through which kerosene flows, in an elastically mounted manner. Stability problems due to different thermal expansion are thus avoided.

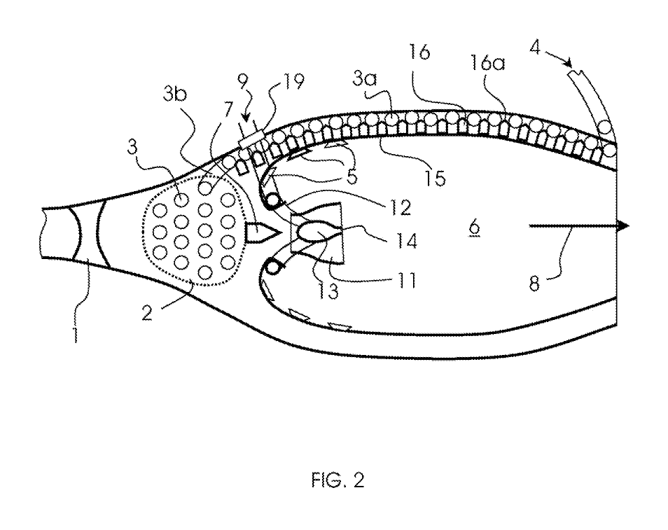

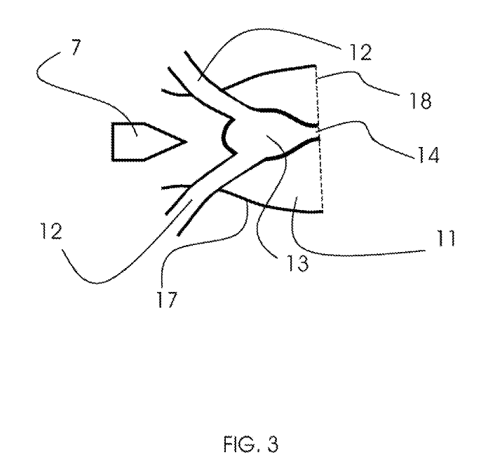

FIG. 2 shows a variation of the embodiment shown in FIG. 1, with a heat exchanger 3a in the outer wall area of the annular combustion chamber 6, which at the same time forms the external housing of the engine. In the discharging area of the combustion chamber, liquefied gas is fed through an inlet 4 into the heat exchanger 3a. The heat exchanger consists of at least two pipes wrapped around each other, which extend in a spiral shape in the direction of the inlet area of the combustion chamber 6. Two pipes are provided in this embodiment for safety reasons in order to distribute the evaporated LNG more quickly via this shorter path. If these two advantages are dispensed with, only a single pipe is enough. In the embodiment shown in FIG. 2, the inlet 4 comprises an annular pipe in the outside area of the engine, into which a feeding line leads and from which two discharging pipes lead to the heat exchanger pipes. The pipes can be coiled in a spiral shape and brought into the outer shell of the combustion chamber in order thus to install the heat exchanger 3a. From the heat exchanger 3a, the liquefied gas is fed into the heat exchanger 3 via a line 3b and finally arrives, in the evaporated form, at the gas nozzle 7. The evaporated liquid gas is injected through the gas nozzle 7, mixed with the compressed air and continuously combusted. In this embodiment, the combustion chamber is cooled by the heat exchanger pipes. The walls of the combustion chamber are thus protected against temperatures that are too high. Due to the fact that a liquefied gas such as LNG is fed into the combustion chamber 6 contrary to the flow, the particularly endangered discharging area out of the combustion chamber is cooled particularly well. Residual hydrocarbons burn off in the discharging area, which cause a particularly great heat to develop here.

FIG. 2 illustrates that the cross section of the pipe of the heat exchanger 3 may also be circular. In another embodiment, however, the heat exchanger 3 may also be omitted, so that air is directly fed from the heat exchanger 3a into the gas nozzle 7 in that case.

Because of the occurrence of strong thermal fluctuations, the pipe 3a extending in a spiral shape is spatially separated by a spacer 16 extending in a spiral shape, in order thus to avoid thermal stresses. With its tip 16a, the spacer squeezes adjacent pipelines apart. The spacer can also be brought, coiled in a spiral shape, into the outer shell of the combustion chamber in order to be installed in this way. Adjacent pipelines are put under tension by the spacer 16. The pipelines of the pipe 3a are thus prevented from being able to oscillate. Moreover, a distance between the pipelines is set. The spacer 16 is, for example, a bent strip extending in a spiral shape.

Moreover, there are stopping members at both ends of the spacer extending in a spiral shape, which are not shown. On the one hand, such a stopping member is disposed in the discharging area out of the chamber. On the other hand, a pipe section of the heat exchanger in the inlet area may, for example, act as a stopping member in order to fixate the spacer 16.

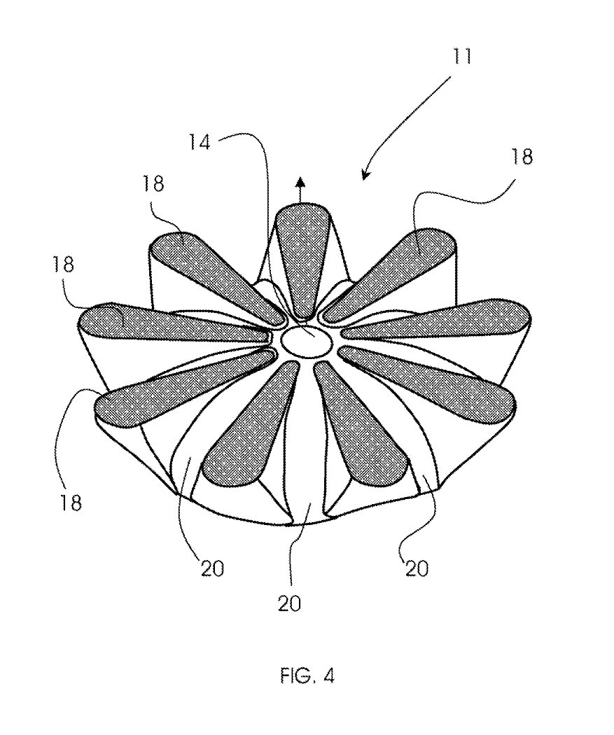

FIG. 3, in an enlarged illustration, shows the nozzle 7 from which evaporated gas exits, which arrives in the outer housing 17 of the mixing nozzle burner 11 from here. On the discharging side of the mixing nozzle burner, the atomized gas-air mixture exits in a controlled manner via perforated metal sheets 18, is mixed here with further externally supplied combustion chamber air and ignited. Through the feeding lines 12, kerosene arrives in the shielded-off area 13, exits from the nozzle opening 14 of an injection nozzle, is then mixed as well as possible with compressed air fed via the outer side of the blossom-shaped mixing nozzle burner to the injection nozzle with atomized kerosene, and is ignited in the combustion chamber.

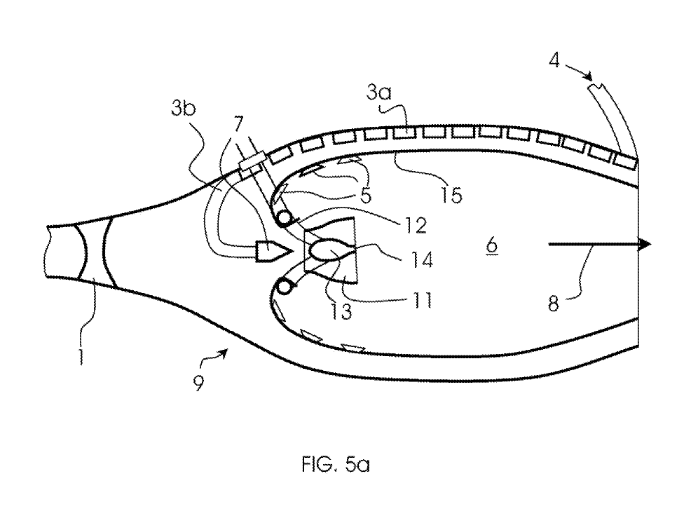

FIG. 4 shows a more detailed three-dimensional representation of the discharging area of the mixing nozzle burner 11. In this case, the mixing nozzle burner 11 comprises, for example, nine outlet ports in the form of perforated plates 18 from which the liquid gas exits in the form of a gas. Theses outlet ports are grouped around an outlet port or nozzle 14 from which the atomized conventional fuel (kerosene) exits. In FIG. 4, an arrow indicates the direction in which the respective atomized fuel exits. The wall 20 is routed towards the second nozzle, the kerosene nozzle, in the inner area by the LNG-air mixture (mixing nozzle burner), and in the outer area by injected air in a blossom shape. Thus, two outlet ports are separated from each other by a wall 20 which slopes from the nozzle opening 14 outwards, downwards or in the direction of the inlet of the combustion chamber. The compressed air is conducted to the outlet ports for the fuel via these walls 20, supported by the Coanda effect. The outlet ports are each covered with a perforated metal sheets 18 in order to produce many small controlled individual gas flames in the combustion chamber.

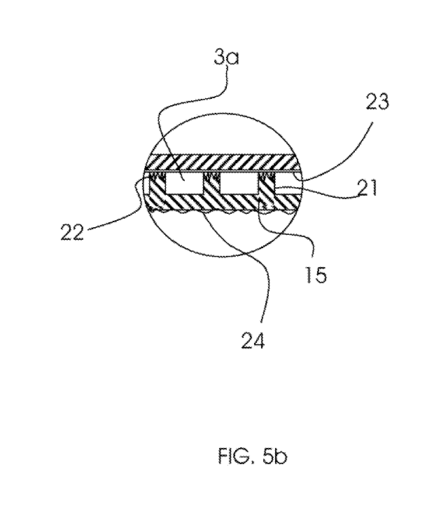

FIG. 5a shows an embodiment of a heat exchanger 3a for exchanging heat with thermal energy occurring in the combustion chamber. In this embodiment, a metal sheet provided with webs 21, which constitutes the inner wall 15, is applied in the area of the combustion chamber onto an outer wall of the drive, which is coated on the inside. The inner coating 22 of the outer wall shown enlarged in FIG. 5b serves for a tight connection between the ends 23 of the webs 21. The ends 23 are furrowed in order to ensure a tight connection. On the inside, the inner wall 15 has a corrugated surface 24 to improve the heat exchange.

If a combustion chamber is to be retrofitted with a heat exchanger 3a, there is the simplified option of coiling a pipe in a spiral shape around the outer wall of the engine in the area of the combustion chamber and to utilize the external heat of the combustion chamber for the evaporation of the liquid gas. This eliminates the advantages of the wall protection etc.

The above-described inventions are advantageous from the standpoint of sound emission because the double walls of the heat exchanger dampen the sound of the combustion. The special configuration of the mixing nozzle burner with the several outlet ports 19 that are grouped around an outlet port 14 makes it possible that two different fuels can be simultaneously or successively mixed and combusted together with the compressed air, with the degree of the mixing enabling an energy-graduated combustion. The special design of the suspended elastically mounted mixing nozzle burner 11 forming a unit together with at least three hollow connecting webs 12, through which kerosene flows, and which in turn form a unit together with the kerosene-feeding annular pipe 12 and the kerosene nozzle 14, enables the consecutively staggered dual use fuel technology. In particular, LNG (liquefied natural gas) or bio LNG (refrigerated methane gas −161° C.), a renewable gas which is available in large quantities on earth and only has to be collected in an ordered manner, is used as a fuel.

1. Turbine drive with a compressor for compressing air, with a nozzle for injecting a first fuel into the compressed air, with a combustion chamber for igniting the air-fuel mixture, characterized in that the drive comprises another nozzle for injecting a second fuel.

2. Turbine drive, according to claim 1, further comprising a heat exchanger for heating the fuel prior to injecting the first fuel into the compressed air.

3. Turbine drive according to claim 2, wherein a space or area for feeding compressed air into it, with a heat exchanger located therein for heating a fuel prior to the injection of the fuel into the compressed air.

4. Turbine drive according to claim 3, wherein the heat exchanger is adjacent to the combustion chamber for exchanging heat.

5. Turbine drive according to claim 4, wherein a mixing nozzle burner with several outlet ports for discharging a second fuel, which are grouped around an outlet port for a first fuel.

6. Turbine drive according to claim 5, comprising walls that separate two adjacent openings for discharging a second fuel from each other and which extend from the outlet opening for the first fuel outwards in the direction of the inlet into the combustion chamber.

7. Turbine drive according to claim 1, comprising a mixing nozzle burner which is connected to the combustion chamber in an elastically mounted manner.

8. Turbine drive according to claim 7, comprising three feed pipes, which, on the one hand, are connected to an outlet port for the first fuel and, on the other hand, to an annular pipe.

9. Turbine drive according to claim 8, wherein the outlet port for the first fuel is a kerosene nozzle

10. Aircraft with a turbine drive according to claim 1, comprising a tank for liquid gas and a fuel cell for generating electric power from the gas forming in the tank.

11. Method for the turbine drive according to claim 1, wherein the drive for a turbine is initiated with a first fuel, and then a second fuel is fed to the drive instead of the first fuel, with the ignition temperature of the second fuel preferably exceeding the ignition temperature of the first fuel.

12. Method for the turbine drive according to claim 1, wherein liquefied gas, in particular LNG, is conducted through a heat exchanger, is thereby evaporated, the gas thus obtained is mixed with compressed air, and this gas-air mixture is ignited.
